(19) United States
(12) Patent Application Publication
(10) Pub. No.: US 2010/0178794 A1
(43) Pub. Date: Jul. 15, 2010

(54) Piercing Terminal, Electric Connector and Their Production Process

(76) Inventor: CHING-JEN HSU, Dongguan (CN)

Correspondence Address: GLOBAL IP SERVICES, 7285 W. Eagle Court, Winton, CA, 95388, US

(21) Appl. No.: 12/510,209

(22) Filed: Jul. 27, 2009

(30) Foreign Application Priority Data
Jan. 14, 2009 (CN) 200910036628.6

(51) Int. Cl. H01R 4/24; H01R 13/02; H01R 43/00

(52) U.S. Cl. 439/391; 439/884; 29/883

(57) ABSTRACT

This invention is about the electric connector and its processing technique. More specifically, it involves terminals with puncture structure, electric connector and their processing technique. The processing technique herein includes stamping terminal processing, winding displacement processing, injection upper cover, injecting lower cover, piercing processing, removal of material ribbon, front glue chip assembly, assembly of outer metal shell. Among them, the upper cover and lower cover are injected and molded in the middle and rear of the corresponding terminals in array. The processing technique has tackled the problems as unstable contact, poor contact, high electric resistance and micromation which cannot be solved by the current existing electric connector. There should be at least two tusks whose tips are intertwined molded in the electric connector of piercing terminal. The tusks are the pyramid shape with a cambered surface in the inner side; it reduces the electric resistance of electric connector. The upper and lower covers of piercing HDMI electric connector are respectively molded in the arrayed terminals. The rear end of the terminal has molded piercing tusk. The electric connector has become smaller and lighter, improving its performance in every aspect significantly.

### CROSS REFERENCE TO RELATED PATENT APPLICATION

The present application claims the priority of the Chinese patent application No. 200910036628.6 filed on Jan. 14, 2009, which application is incorporated herein by reference.

### FILED OF THE INVENTION

This invention is about the electric connector and its processing technique; specifically, it touches upon piercing terminal, electric connector and its production process.

### BACKGROUND OF THE INVENTION

Currently the existing electric connectors include HDMI, DVI, DisplayPort, VGA, Fi-X. Such electric connectors play significant role in electric products. It is responsible for the data transmission and signal sending between electric products, such as the High-Definition Multimedia Interface (HDMI). HDMI can provide transfer rate as much as 10 Gbps and it can transfer high-quality video signals uncompressed and with no need for conversion, suitable for the use in digital appliance such as digital TV, DVD player, DVD broadcaster and other digital video and audio products.

The current connection between the terminal and the core wire within the electric connector is the welding. Since the terminal is connected with the core wire within the electric connector by welding, which has unstable quality, the solder joints are varied in sizes and the welding performance is poor and has low yields of good products. The welding is connecting the core wire one by one to the electric contact section of the terminal. The whole process is by human hand, with low efficiency. In addition, the unit rate of the tin threads used for the welding is high, and the tin soldering will generate soldered splash and waste gas, which pollute the operation environment. Meanwhile, it requires a lot of tin soldering equipment and tools and the costs for labor, materials and production, which cause the product cost stand high.

To solve this problem some companies currently invented the electric connector with piercing structure. For instance, the Chinese patents named HDMI terminal and connection structure of signal lines with Patent No. 200520111381.7 discloses the terminal and signal line connection structure of an HDMI connector with piercing structure, with which there is no need of welding between the electric connector's terminal and the core wire, getting rid of the various problems brought forth by the welding process. However, the forked contact of the HDMI terminal in this patent is thin metal sheet and it is horizontal in-line mode. The ends of the core wires need a bending section, and an upper cover to fixate each core wire. Only so the forked contact section at the tail of the terminal can pierce into the core wires. There are the following problems: 1. since the forked contact section is of the horizontal in-line mode. There is the fit clearance caused by the assembly between the electric connector components. The components that are part of the electric connector may be loose off. Therefore, the contact between the forked contact section and the core wire is not stable. Poor electric contact can easily occur between the terminals and the core wires, which can not only make the electric connector have very poor performance, but also affect the normal use of the connectors. Some electric connectors cannot be used. This is absolutely not allowed. 2. The volume of the electric connectors adopting this structure is still very large. Since the terminals with puncture structure, the core wires require some space, and the upper cover also takes up some space, the volume of the electric connector cannot be reduced and its thickness cannot be reduced. So the electric connectors cannot be micronized or miniaturized. The electric connectors cannot meet the needs for being micro and miniaturized required by various electronic appliances. 3. The forked contact section of the terminal is a thin metal sheet with shape of a scissor edge. The forked contact section has point contact with the conductor in the core wires, and the contact area is very small. The electric resistance of the electric connector is high, causing very low transfer rate of the electric connector and the poor high-frequency characteristics. This severely affects the performance of the electric connectors.

### SUMMARY OF THE INVENTION

This invention provides a processing technology for an HDMI electric connector with piercing structure to solve the problem of existing technologies. This process is simple and easy to implement, tackling the unstable electric contact and high electric resistance that cannot be solved by the current HDMI electric connector with piercing structure. In the mean time, the HDMI electric connector with piercing structure has been micro and slimming.

Another purpose of this invention is to provide a piercing terminal to offset the disadvantages of current technology. The contact area between the tusk and the conductor in the core wire is very large, which can reduce the electric resistance in the electric connector. Meanwhile, the terminal in this structure is good for the HDMI electric connector to become micro and slimming.

One third purpose of this invention is to provide an HDMI electric connector with piercing structure to offset the disadvantages of existing technology, which can make the electric connector more micro and slimming. It has solved the problems of poor contact and low electric resistance that are unsolvable to the current electric connector of piercing structure.

This invention achieves the above purpose through the following technical solutions

The processing technology of an HDMI electric connector with piercing structure includes the following steps:

Process of stamping terminal: the terminal molded by stamping has the electric contact section as the front end, the shaft as the middle and the electric contact section as the terminal rear. There are tusks molded on the electric contacts.

Winding displacement processing: array the core wires and fixate them in the wire chase on the upper surface and lower surface of the winding displacement rubber plug.

Injection molding of upper cover: place a group of terminals distributed on the upper cover inside the injection molds. The middle and rear section of this arrayed terminals are injected, molded and get out of the upper cover, while the middle and rear section of the terminals are imbedded in the upper cover. The tusk in the electric connector stands upright on the inner surface of the upper cover. The rear end of the upper cover forms the piercing zone for the first terminal.

Injection of lower cover: place a group of terminals distributed on the lower cover inside the injection molds. The middle and rear section of this arrayed terminals are injected, molded and get out of the lower cover, while the middle and rear section of the terminals are imbedded in the lower cover. The tusk in the electric connector stands upright on the inner surface of the lower cover. The rear end of the lower cover forms the piercing zone for the second terminal.

Piercing processing: assemble the upper cover, lower cover and the winding displacement rubber plug fixated with core wires. The upper and lower buckets of upper cover and lower cover should be fastened. There is the wire chase in the winding displacement rubber plug, and the wire chase section is pressed between the first terminal piercing zone and the second terminal piercing zone at the rear of the upper cover and the lower cover. The tusks in the upper cover and the lower cover piece into the core wire within the corresponding wire chases, and connect with the conductor inside the corresponding core wire.

Removal of material ribbons: remove the material ribbons in the terminals of upper cover and lower cover.

Assemble the front rubber core wires: place the front rubber core wires in the front of the upper cover and lower cover. The front rubber core wires, the upper cover, the lower cover and the winding displacement rubber plug assemble into a flat combination of electric connector.

Assemble the outer metal shell: place the outer metal shell outside the electric connector combination assembled from front rubber core wires, the upper cover, lower cover and the winding displacement rubber plug.

The finished product of HDMI electric connector with piercing structure.

In the above process, the mentioned process of stamping terminal includes the following process:

The terminals distributed by stamping on the upper cover, there must be at least a group of terminals distributed on the upper cover by stamping; the terminals from stamping have been arrayed and connected by the material ribbons.

The terminals distributed by stamping on the lower cover, there must be at least a group of terminals distributed on the lower cover by stamping; the terminals from stamping have been arrayed and connected by the material ribbons.

A ribbon connects with at least an array of terminals distributed on the upper cover and/or an array of terminals distributed on the lower cover.

The tusks stamped from the terminals are arrayed in the electric contact section of the terminal. The tusk is of pyramid shape. The inner side of the tusk forms a contour. The tusk forms a V-shape or U-shape holding frame of core wires on the vertical projecting frame. The front end of the terminal turns 90 degrees around the rear end of the terminal and one torsion section has emerged in the shaft.

In the above process, the mentioned injection molding of upper cover is replaced by the processing of upper cover assembled terminal; or the mentioned injection molding of lower cover is replaced by the processing of lower cover assembled terminal. The processing of upper cover assembled terminal is: injection molding, assemble an array of terminals distributed on the upper cover, and the rear of upper cover forms the first terminal piercing zone. The processing of lower cover assembled terminal is: injection molding, assemble an array of terminals distributed on the lower cover, and the rear of upper cover forms the second terminal piercing zone.

In the above process, one step to inject the inner mold is added before the puncture process. That's to place the winding displacement rubber plug inside the injection mold, and take out the inner out when the rear end of winding displacement rubber plug has been molded by injection. The inner mold is fixated in the rear of winding displacement rubber plug. Meanwhile, the internal mold covers and fixates completely all the core wires.

in the above process, as you assemble the front rubber core wires, the hooks on the upper cover and the lower cover are snapped into the lock joints on both the upper surface and lower surface of the front rubber core wires, which can thus fixate the front rubber core wire on the front end of the upper cover and the lower cover.

In the piecing process, the fastening of the upper cover and the lower cover is done through the pressing by fixture and hold-down clamp, or by manual pressing. The upper cover and the lower cover are respectively positioned and steered through the location pillar and the reference hole on their inner surface.

In the step of assembling the outer metal shell, the mentioned outer metal shell is the level and flat shell whose rear is connected with the upper buckling part and the lower buckling part. After the outer metal shell is assembled, the upper buckling part and the lower buckling part are fastened and joined.

In the above process, one step of injecting the plastic shell is added before the outer metal shell assembling process. That's to place the outer metal shell and the electric connector combination inside the injection mold, and inject a plastic shell outside the outer metal shell.

A terminal with puncture structure: the front end is the electric contact section, the terminal middle is the shaft and the rear is the electric contact section. Above the electric contact section there are at least two tusks with intertwining tips. The tusks are of pyramid shape. The inner sides of the tusk form a cambered surface.

Furthermore, in the abovementioned terminal with puncture structure, there are three tusks arrayed in the electric contact. The medial surfaces of the tusks located in the front end and rear end are of the same direction, and they are of the opposite direction of the medial surface of the tusk located in the middle. The cambered surface is formed on the upper end of the tusk's inner surface.

Furthermore, in the abovementioned terminal with puncture structure, the said tusks form a V-shape or U-shape holding frame for the core wires.

Furthermore, in the abovementioned terminal with puncture structure, the front end of the terminal turns 90 degrees around the rear end of the terminal, and a torsion section is formed on the shaft.

The components of puncture terminals of the HDMI electric connector with puncture structure includes the upper and lower covers whose top and bottom are fastened and joined. The upper cover is molded by injection in the middle and rear ends of the arrayed terminals. The terminal shaft and the back of terminal rear are imbedded in the upper cover. There is the upper cover trough in the rear of upper cover. The tusk in the electric connector at the rear of the terminals is located in the trough of the upper cover, and the tusk protrudes to the inner surface of the upper cover trough.

The lower cover is molded by injection in the middle and rear ends of the arrayed terminals. The terminal shaft and the back of terminal rear are imbedded in the lower cover. There is the lower cover trough in the rear of lower cover. The tusk in the electric connector at the rear of the terminals is located in the trough of the lower cover, and the tusk protrudes to the inner surface of the lower cover trough.

An HDMI electric connector with puncture structure includes the winding displacement rubber plug, the upper cover, the lower cover, the terminal, the front rubber core wires and the outer metal shell. The core wires are arrayed and fixated in the winding displacement rubber plug. The upper cover is molded by injection in the arrayed terminals. There are tusks formed in the rear of the terminals. The tusks stand upright on the inner surface of the upper cover.

The lower cover is molded by injection in the arrayed terminals. There are tusks formed in the rear of the terminals. The tusks stand upright on the inner surface of the lower cover. The top and bottom of the upper and lower covers are fastened and joined. The winding displacement rubber plug is pressed in the rear of the upper and rear covers. The tusks in the terminals of the upper cover and the lower cover separately pierce the corresponding core wires which are fixated in the winding displacement rubber plug, and the tusks are connected with the conductors in the corresponding core wires.

The outer metal shell covers the outside of the front rubber core wire, the upper cover and the lower cover from front to the back.

Furthermore, in the abovementioned HDMI electric connector with puncture structure, the terminal front is the electric contact section, the terminal middle is the shaft and the terminal rear is the electric contact section. The terminal shaft and the back of terminal back are imbedded within the upper cover or the lower cover. There are at least two tusks whose tips are intertwining molded on the electric contact section. The tips of the tusks lean to the outside. The tusks are of pyramid shape. The internal sides of the tusks form a cambered surface.

Furthermore, in the abovementioned HDMI electric connector with puncture structure, there are three tusks arrayed in the electric contact. The medial surfaces of the tusks located in the front end and rear end are of the same direction, and they are of the opposite direction from the medial surface of the tusk located in the middle. The cambered surface is formed on the upper end of the tusk's inner surface.

The three tusks form a V-shape or U-shape holding frame for the core wires on the vertical projecting plane. The front of the terminal turns 90 degrees around the rear of the terminal, and a torsion section is formed in the shaft.

Furthermore, in the abovementioned HDMI electric connector with puncture structure, the two sides of the upper cover extend downward to the buckling feet. There is the button placement molded on the two sides of the lower cover. When the upper cover and the lower cover are fastened, the buckling foot of the upper cover is locked into the button placement of the lower cover. There is a hook on the outer surface of the said upper cover and there is a hook on the outer surface of the said lower cover. There are the windows going through the rubber core wires on the upper surface and lower surface of the front rubber core wire. When the front core wire is assembled on the front ends of the upper cover and the lower cover, the hooks of the upper cover and the lower cover hook the windows. There are wire chases formed on the upper surface and lower surface of the mentioned winding displacement rubber plug. There is the inner mold's filling chamber at the rear of the winding displacement rubber plug. There is one inner mold injected in the filling chamber at the rear of the winding displacement rubber plug and the inner mold covers and fixates each core wire.

Furthermore, in the abovementioned HDMI electric connector with puncture structure, the said outer metal shell is a one-piece type. The outer metal shell is the level and flat shell. There is the upper buckling part and the lower buckling part at the rear of the outer metal shell. After the outer metal shell is assembled, the upper buckling part and the lower buckling part are joined. There is the plastic shell injected outside the outer metal shell.

This invention is beneficial in that the process includes the processes of stamping terminals, winding displacement, upper cover injection, and lower covers injection, piercing, removing the material ribbons, assembling the front rubber core wires and assembling the outer metal shell. The upper cover and the lower cover are injected at the middle and the rear ends of the corresponding arrayed terminals.

The processing in this invention can not only offset the various problems caused by welding, it has also solved the problems of poor contact and low electric resistance that are unsolvable to the current HDMI electric connector of puncture structure. Meanwhile, it makes it come true that HDMI electric connector with puncture structure has become micro and slimming.

Another benefit of this invention is that: there are at least two tusks with intertwining tips formed at the electric connection section of the terminals with puncture structure. The tusks are of pyramid shape. The internal sides of the tusks form a cambered surface. The contact area between the tusks and the conductor in the core wires is large, which can reduce the electric resistance. Meanwhile, terminals with this structure are beneficial for the HDMI electric connectors to become micro and slimming.

Another benefit of this invention is that: the upper cover and the lower cover of the HDMI electric connector with puncture structure are separately arrayed on the terminals. There are the piecing tusks formed at the rear of the terminals. The tusks stand uptight on the inner surface of the upper cover and the lower cover. When the upper cover and the lower cover are connected, the tusks of the upper cover and the lower cover have electric contact with the conductor after the tusks pierce into the corresponding core wires. The electric connectors have become more micro and slimming and the terminals with puncture structure have stable contact with the core wires. The electric resistance is low, which can greatly enhance the performance of the electric connectors in every aspect.

### BRIEF DESCRIPTION OF THE DRAWINGS

FIG. 1 is the process flow chart for this invention

FIG. 2 is the structural diagram for this invention;

FIG. 3 is the structure diagram of core wires arrayed and fixated in the winding displacement rubber plug;

FIG. 4 is the structure diagram for inner mold injected from the rear of winding displacement rubber plug which have arrayed core wires

FIG. 5 is the structure diagram for terminals from stamping together with some material ribbons;

FIG. 6 is the structure diagram for the lower cover injected on the terminals in the Attached drawing 5

FIG. 7 is the structure diagram for a lower cover with a single terminal;

FIG. 8 is the top plan view for Attached drawing 7;

FIG. 9 is the structure diagram for the upper cover from stamping together with terminals;

FIG. 9 10 is the structure diagram for he upper cover from stamping together with terminals from another perspective;

FIG. 11 is the top plan view for the Attached drawing 10;

FIG. 12 is the structure diagram for the winding displacement rubber plug assembled at the rear of the lower cover;

FIG. 13 is the structure diagram for the winding displacement rubber plug and the lower cover in Attached drawing 12 from another perspective;

FIG. 14 is the structure diagram for the upper cover and the lower cover Attached drawing 12 connecting together;

FIG. 15 is the structure diagram for the upper cover, lower cover and the winding displacement rubber plug in Attached drawing 14 from another perspective;

FIG. 16 is the structure diagram for the terminals in Attached drawing 14 without the material ribbons;

FIG. 17 is the structure diagram for the terminals in Attached drawing 14 without the material ribbons from another perspective;

FIG. 18 is the structure diagram for the core wires before the upper cover and lower cover in Attached drawing 16 are assembled;

FIG. 19 is the structure diagram for the terminals in this invention;

FIG. 20 is the principle view of Attached drawing 19;

FIG. 21 is the back view of Attached drawing 19;

FIG. 22 is the top plan view for Attached drawing 19;

FIG. 23 is the enlarged view of the left views in Attached drawing 19;

FIG. 24 is the structure diagram for the conductor being clamped against the tusks that pierce into the single-wired core wires;

FIG. 25 is the structure diagram for the conductor being clamped against the tusks that pierce into the multi-wired core wires;

FIG. 26 is the back view of FIG. 25.

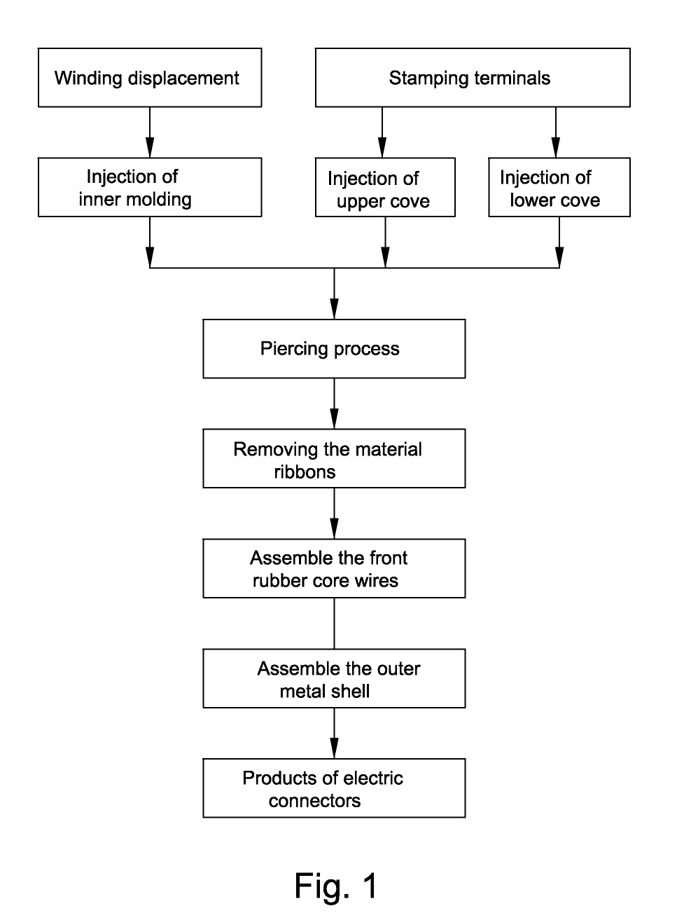

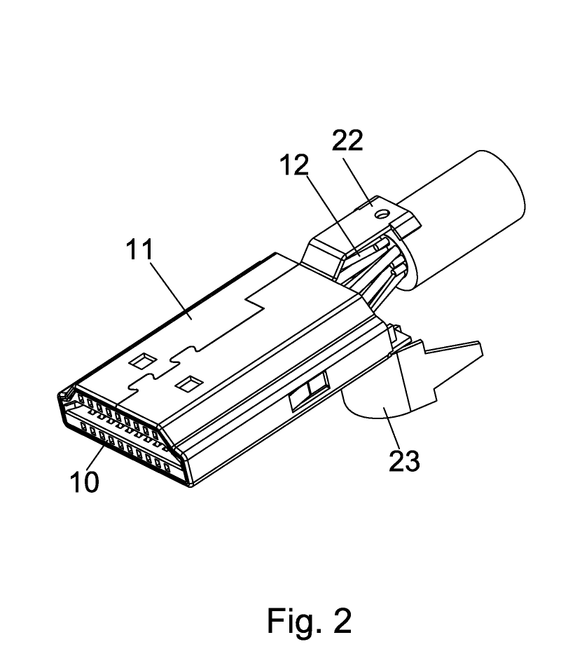

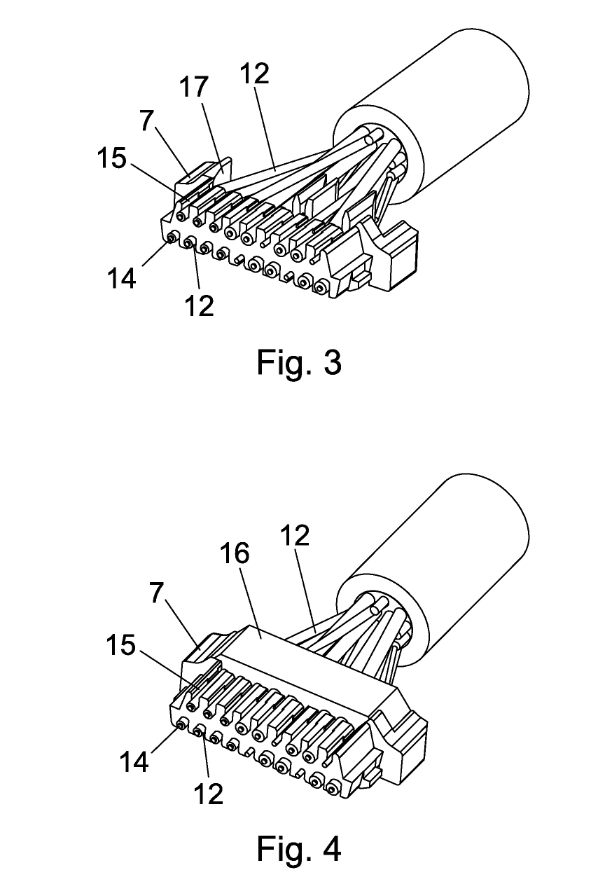

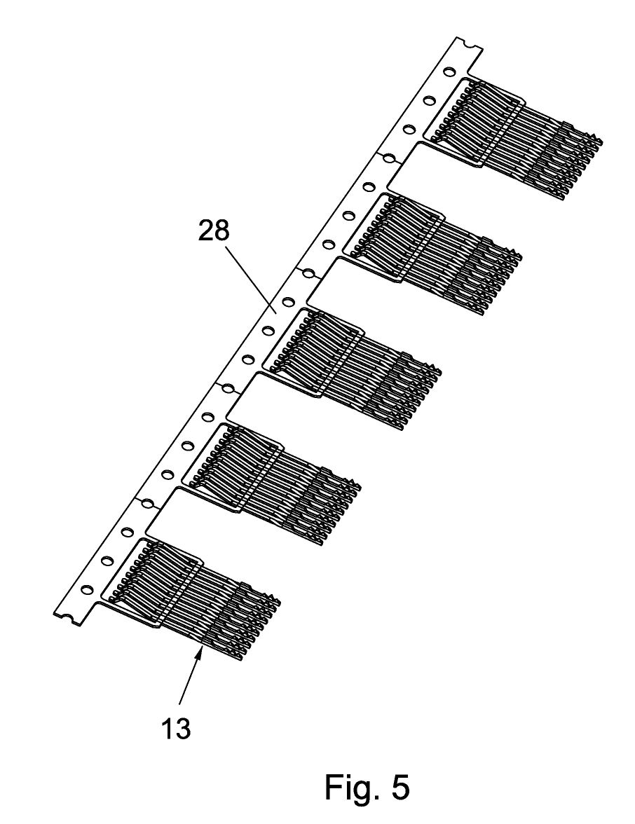

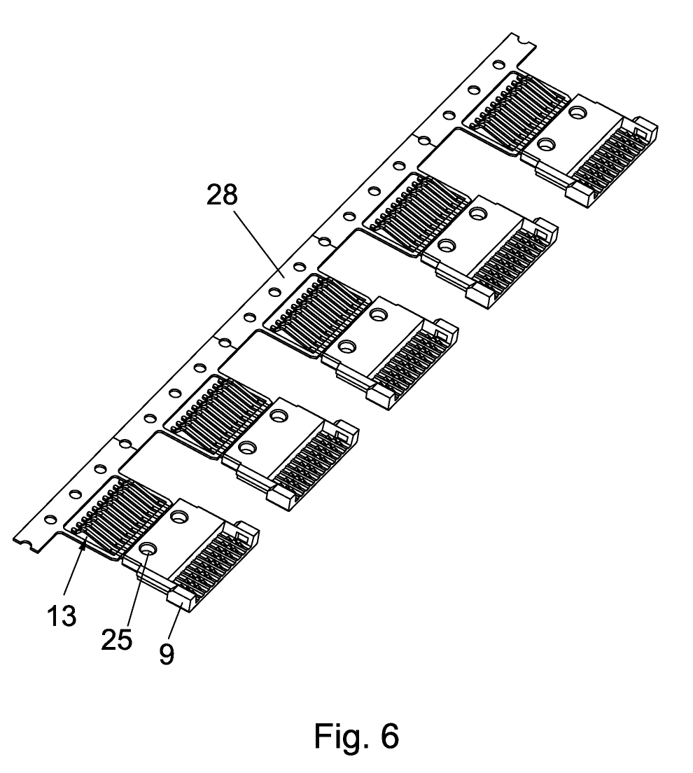

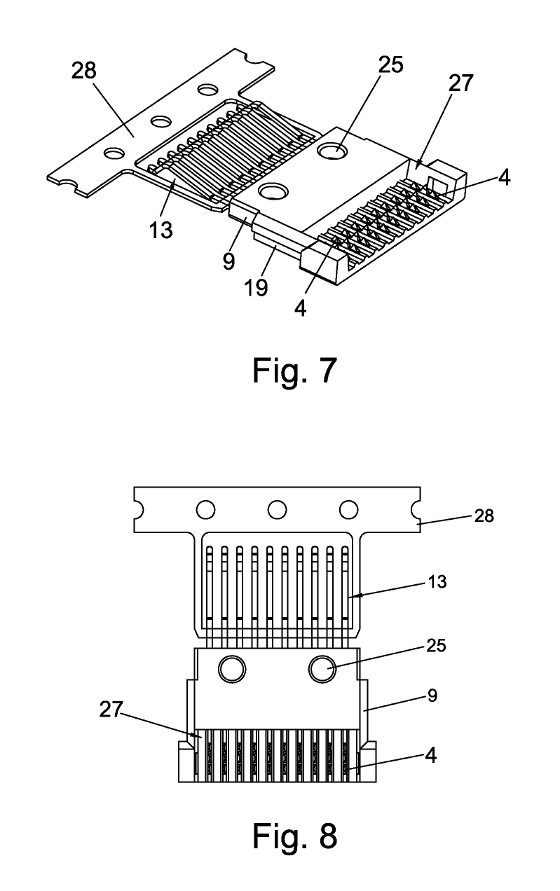

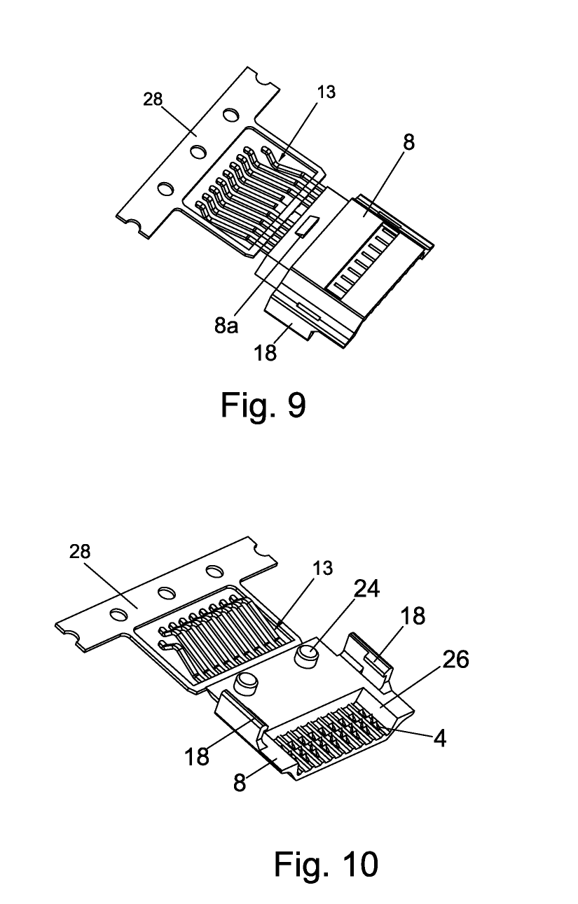

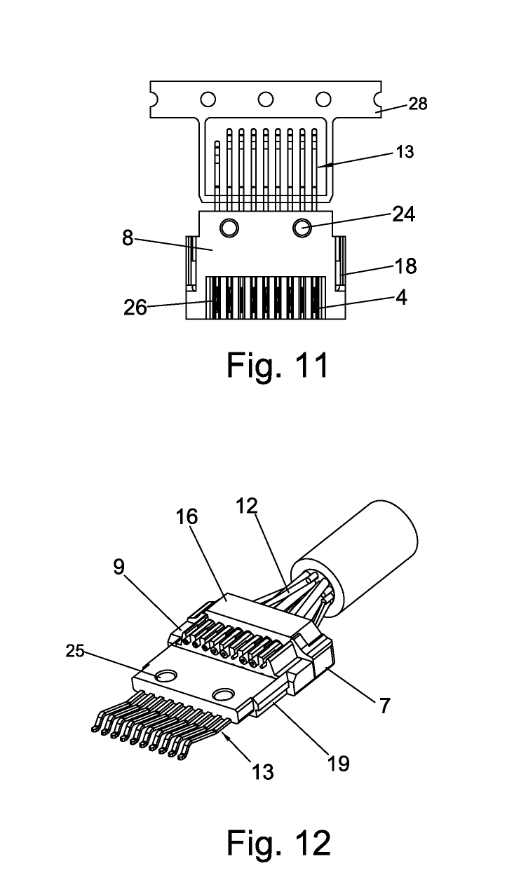

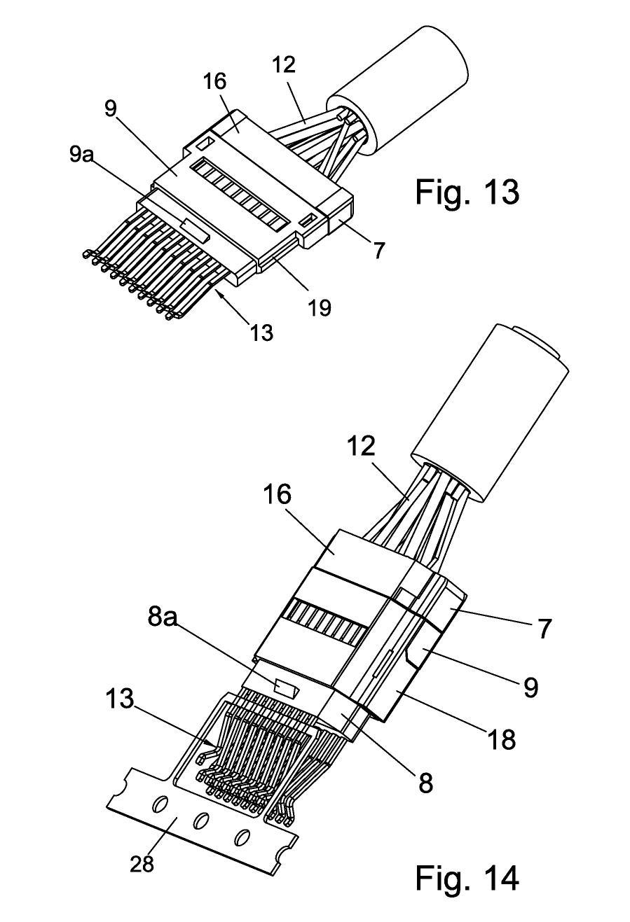

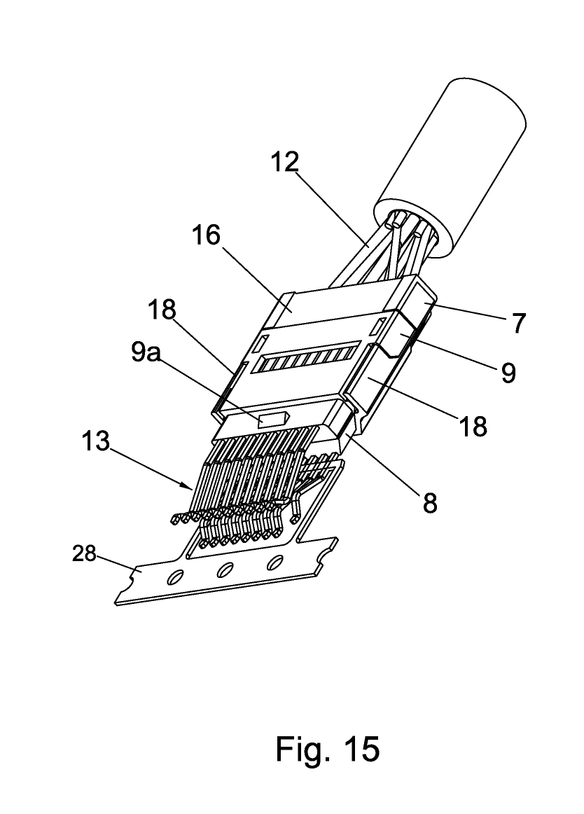

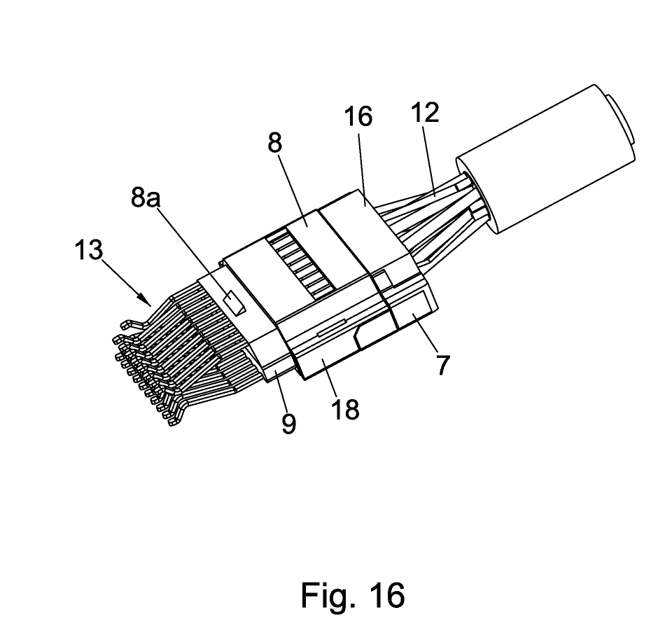

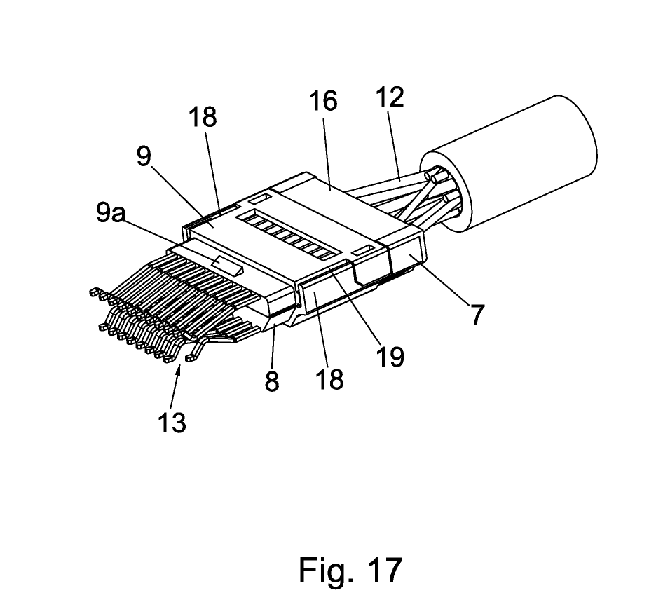

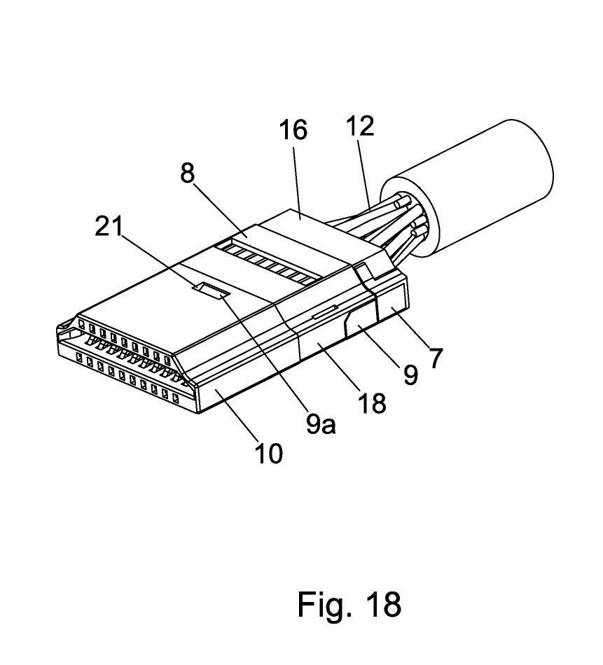

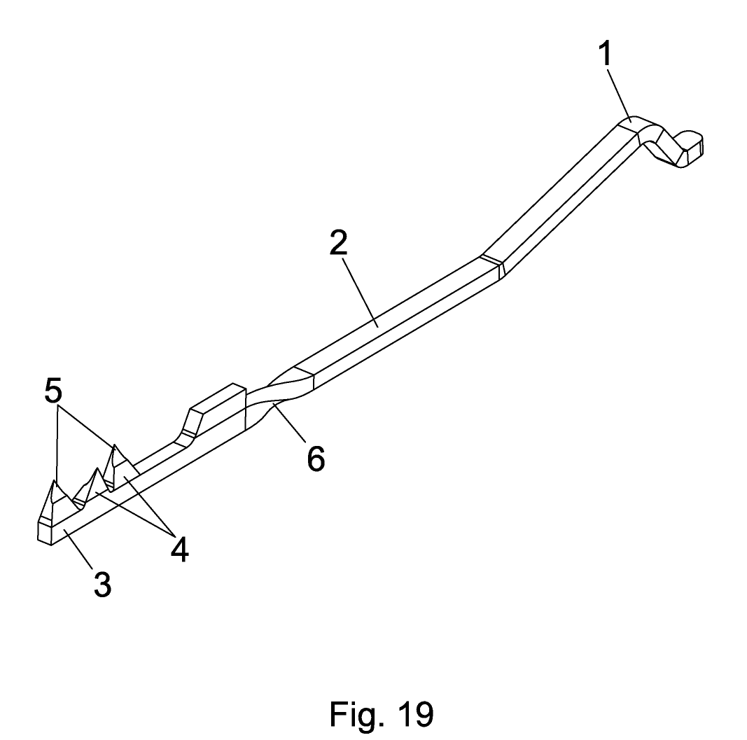

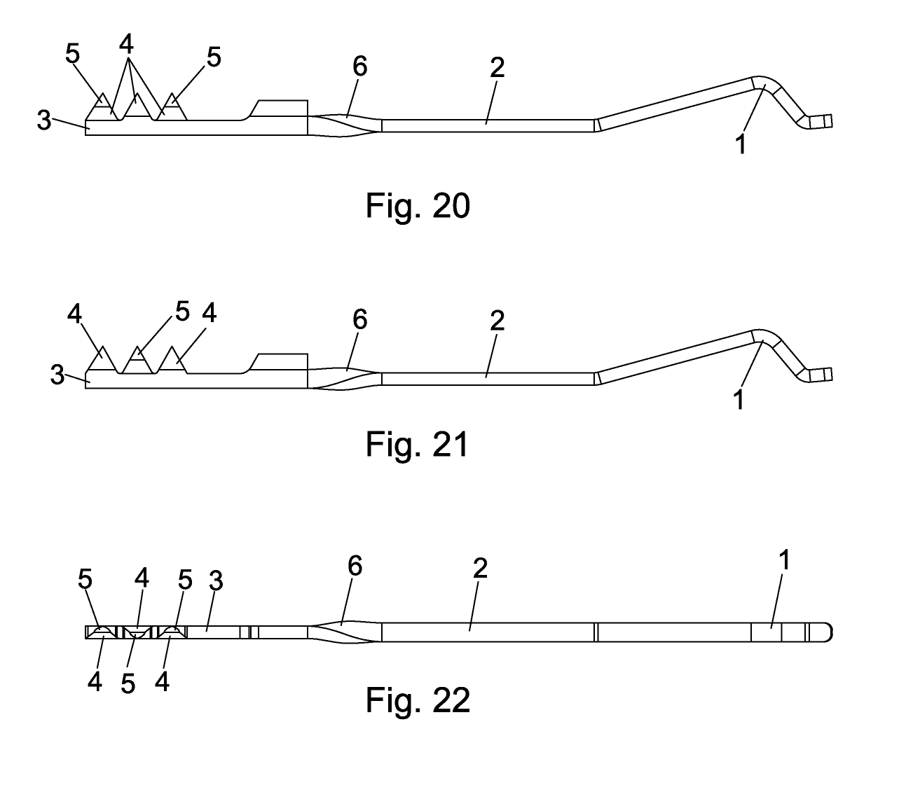

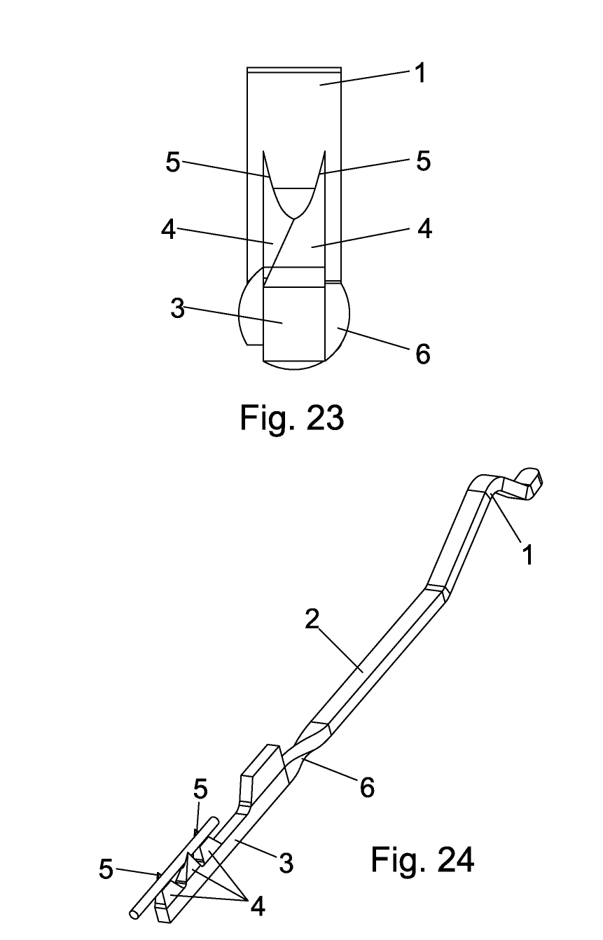

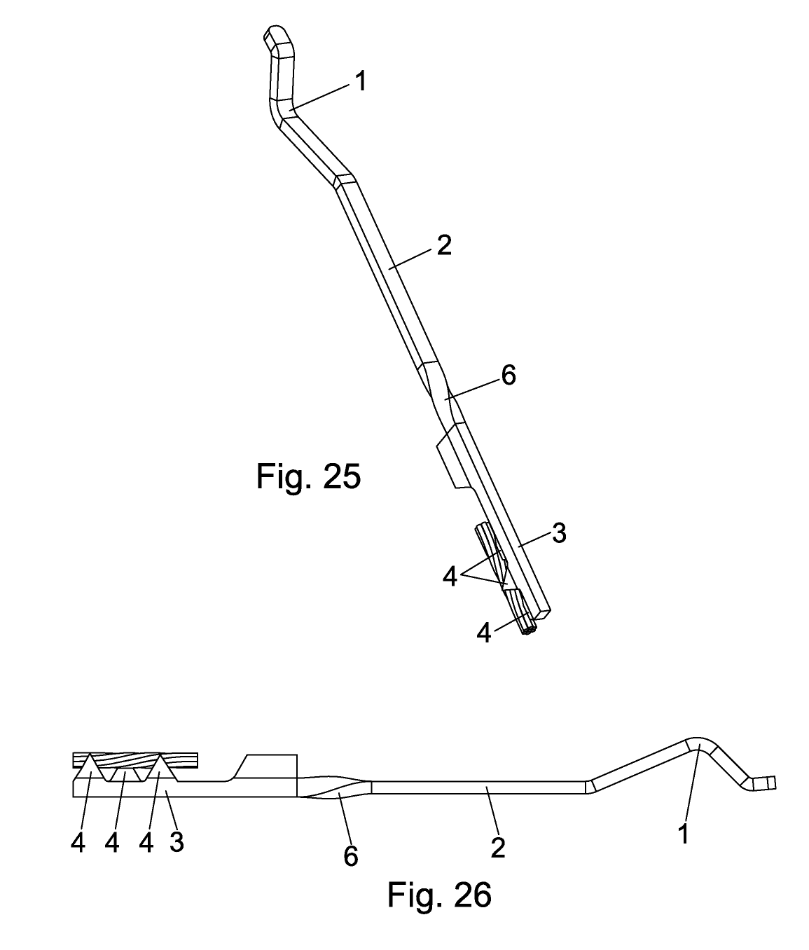

### PREFERRED EMBODIMENTS FOR CARRYING OUT THE INVENTION

### Embodiment 1

The processing for the HDMI electric connector with puncture structure, referring to Attached drawing 1, includes the following steps:

Stamping terminal processing, terminal (13) from stamping molding, as shown in attached drawings 19 to 23. The front of terminal (13) is the electric contact section (1). The middle of terminal (13) is the shaft (2); the rear of terminal (13) is electric contact section (3). There are three tusks (4) with intertwining tips in electric contact section (3). The three tusks (4) are arrayed on the electric contact section (3) of the terminals (13). The tusks (4) from stamping are of pyramid shape. The internal sides (5) of tusks (4) form the cambered surface.

The internal sides(5) of the tusks(4) located in the front end and the rear end are of the same direction, and are of the opposite direction from internal sides(5) of the tusk(4) located in the middle. The three tusks (4) make a V-shape or U-shape holding frame for the core wires in the vertical projecting surface.

The front end of terminal (13) turns 90 degrees around the rear end of terminal (13). The shaft (2) forms a torsion section (6). The torsion section (6) makes the terminal (13) join better with the upper cover 8 or lower cover 9. When the upper cover 8 or lower cover 9 is injected and molded, the shaft(2) can be more firmly imbedded within upper cover (8) or lower cover(9), thanks to the existence of torsion section(6). The terminals (13) will not become loose off or take off.

In addition, it is hard or impossible to stamp the tusk (4) of pyramid shape with is vertical to the shaft (2) of terminal (13) on the terminals (13), therefore, the design of torsion section 6 in shaft (2) can not only make tusks (4) vertical to the shaft (2) of terminals (13), but also simplify the structure of terminals (13), making it easier for production. It can also make it possible to mechanize, automatize and industrialize the production of terminals (13), especially the tusks (4) of terminals (13).

The stamping process for the terminals in this invention can be as the following method: first the electric contact section(1) of the terminal(13) is stamped out, then shaft(2) and the tusks(4) placed horizontally, and then turn shaft(2) by 90 degrees. After the turning, the tusks (4) of electric contact section (3) are vertical to shaft (2) of terminals (13). It can make the production of terminals (13) more simplified. Also, it makes it possible for the electric contact section to become micro and slimming. You can get smaller thickness if you use of electric connectors of terminals (13).

Furthermore, the stamping of terminals includes the following four methods:

The 1^{st} method: stamp an array of terminals (13) distributed on upper cover (8) or an array of terminals (13) distributed on lower cover (9) separately by the press machines. The terminals (13) distributed on the upper cover (8) are connected by a material ribbon (28) and arrayed according to the location sequence of electric connectors.

The terminals (13) distributed on the lower cover (9) are connected by a material ribbon (28) and arrayed according to the location sequence of electric connectors.

The 2^{nd} method: stamp an array of terminals (13) distributed on upper cover (8) or an array of terminals (13) distributed on lower cover (9) separately by the press machines. The terminals (13) distributed on the upper cover (8) and the terminals (13) distributed on the lower cover (9) are connected by the same material ribbon (28). The terminals (13) distributed on the upper cover (8) and the terminals (13) distributed on the lower cover (9) are arrayed according to their location sequence of electric connectors.

The 3^{rd} method: stamp many arrays of terminals (13) distributed on upper cover (8) or many arrays of terminals (13) distributed on lower cover (9) separately by the press machines. A material ribbon (28) connects the arrays of terminals (13) distributed on the upper cover (8) and the terminals (13) distributed on the lower cover (9). Each array of terminals (13) distributed on the upper cover (8) and the terminals (13) distributed on the lower cover (9) can be distributed continuously or distributed with intervals. Any array of terminals (13) distributed on the upper cover (8) and the terminals (13) distributed on the lower cover (9) are arrayed according to the location sequence of the electric connectors.

The 4^{th} method: for stamping the terminal distributed on the upper cover (8), see the attached drawing 5. Stamp many arrays of terminals (13) distributed on upper cover (8) by the press machines. The terminals (13) from stamping are still connected by the material ribbon (28). A material ribbon (28) connects each array of terminals (13) distributed on the upper cover (8). Any array of terminals (13) distributed on the upper cover (8) are arrayed according to the location sequence of the electric connectors.

Also, stamp the terminal distributed on the lower cover (9). Stamp many arrays of terminals (13) distributed on lower cover (9) by the press machines. Another material ribbon (28) connects each array of terminals (13) distributed on the lower cover (9). Any array of terminals (13) distributed on the lower cover (9) are arrayed according to the location sequence of the electric connectors.

What needs attention is that the terminals (13) stamped in advance are still connected by the material ribbon (28) and the terminals (13) have been arrayed. The material ribbon (28) can array and fixate each terminal (13). Therefore, it is very convenient to inject the upper cover (8) on the terminal (13). There is no need of special tools or hold-down clamp to fixate the terminals (13). In addition, the stamping process of terminals (13) and the injection process of upper cover(8) or lower cover(9) can be done by machines, especially for the continuous processing and automatized processing. Terminal stamping, upper cover or lower cover injection can undergo continuous and automatized processing through the assembly line, which reduce some processing sections in the middle. It has changed the traditional processing method of electric connectors, reducing the number of operators at the assembly line, thus reducing the labor costs.

For winding displacement processing, please see the attached drawing 3. There are the wire chases (15) corresponding to the installation location of terminals (13) on the upper surface and lower surface of winding displacement rubber plug (7). Winding displacement process arranges and fixates the core wire (12) on the upper surface and the wire chase (15) on the lower surface of winding displacement rubber plug (7).

For injecting the inner mold, see attached drawing 4. Place the winding displacement rubber plug (7) inside the injection mold. Inject the inner mold (16) at the rear of winding displacement rubber plug (7). The inner mold (16) is fixated at the rear of winding displacement rubber plug (7). Meanwhile, the inner mold (16) covers and completely fixates all core wires (12). Thus, each core wire (12) can be completely fixated by inner mold (16) to ensure core wires (12) not to take off from the wire chases (15).

For injecting upper cover, see attached drawings 9 to 11. : place a group of terminals distributed on the upper cover (8) in the injection mold. Inject the upper cover (8) on the middle and rear sections of this group of arrayed terminals (13) the middle and rear sections of terminal (13) are imbedded in upper cover (8). Furthermore, shaft (2) of terminals (13) and the back of electric connector (3) are imbedded in the upper cover (8). It can fixate the terminals (13) more firmly on the upper cover (8).

The tusk (4) of electric connector (3) stands on the inner surface of upper cover (8). The rear end of upper cover (8) forms the first piercing zone for the terminals.

Furthermore, there is the upper cover trough (26) at the rear end of upper cover (8). Each tusk (4) is located within the upper cover trough (26). The upper cover trough (26) is used for holding the winding displacement rubber plug (7). The unique combination of upper cover (8) and the terminals (130 make the structure simpler, allowing the volume of the electric connector to be more micro and slimming. Terminals (13) are firmly connected with upper cover (8). The injection process for the upper cover (8) has been mechanized and automatized, which can reduce the work time and production costs.

For Injecting lower cover, see attached drawings 6 to 8: place an array of terminals(13) distributed on the lower cover(9) in the injection mold; mold and inject the lower cover(9) in the middle and rear section of this array of distributed terminals. The middle and rear section of terminals (13) are imbedded in the lower cover (9). Furthermore, the shaft (2) of terminals (13) and the back of electric contact section (3) are imbedded in the lower cover (9). It can make the terminals (13) fixate on the lower cover (9) more firmly.

The tusk (4) of electric contact section (3) stands on the inner surface of lower cover (9). The rear of lower cover (9) forms a second terminal piercing zone.

Furthermore, there is the lower cover trough (27). Each tusk (4) is within lower cover trough (27), which is used for holding the winding displacement rubber plug (7). The unique combination of lower cover (9) and the terminals (13) makes its structure simpler and allows the volume of the electric connector to be more micro and slimming. II And the terminals (13) and the lower cover (9) are firmly joined. The injection process of the lower cover (9) has become mechanized and automatized, which can save the time and reduce the production costs.

There is the position pillar (24) and the position hole (25) on the internal surface. Of said lower cover (9). When the upper cover(8) and the lower cover(9) are joined, the position pillar(24) is insert into the position hole(25) and the position pillar(24) and the positioning hole(25) play the role of steering and positioning to prevent the misallocation when the upper cover(8) and the lower cover(9) are joined.

What needs attention is that the abovementioned processes of stamping terminals, winding displacement, upper cover injection and lower cover injection can be conducted separately. The process sequence does not need to follow the written sequence strictly in this invention. Also, the injection of inner mold is proceeded after the winding displacement processing. And the injection of upper cover and lower cover is done after the terminal stamping process.

What needs attention is that: in terms of the processing technology in this invention, the mentioned upper cover injection can be replaced by the process of upper cover assembled terminal. Or he mentioned lower cover injection can be replaced by the process of lower cover assembled terminal. That is to say, there is one related assembled structure and the processing in the upper cover (8) and lower cover (9) which can be replaced by the existing technology. Of course, when the process of upper cover injection or lower cover injection is replaced, the costs for the electric connectors will also rise, and also lower the performance, which is not good for reducing the electric connector's thickness or micrination. There fore, herein only description of execution modes is given and no embodiment examples will be given. For instance, one execution mode is to replace the upper cover injection by the process of upper cover assembled terminal. The detailed steps are: first, inject the upper cover (8), and then assemble an array of terminals distributed on the upper cover (8) above the upper cover (8); the rear of upper cover (8) forms the first piercing zone. Another execution mode for this invention is to replace the lower cover injection by the process of lower cover assembled terminal. The detailed steps are: first, inject the lower cover (9), then assemble an array of terminals distributed on the lower cover (9) above the upper cover(8); the rear of lower cover(9) forms the second piercing zone.

For piercing processing, see attached drawings 14 and 15. assemble upper cover(8), lower cover(9) and the winding displacement rubber plug(7) fixated with core wires(12), join the top and bottom of the upper cover(8) and the lower cover(9). The top and bottom of upper cover (8) and lower cover (9) are joined and pressed by the tools and the hold-down clamp, or by manual pressing. During the joining process, you can assemble the winding displacement rubber plug above the lower cover(9), and then press the upper cover(8) atop the lower cover(9). During the joining process, the upper cover (8) and the lower cover (9) are positioned and directed by the positioning pillar (24) or the positioning hole (25). The upper cover (8) and the lower cover (9) are joined by the locking foot (18) or the button placement (19).

There is the trough section with a trough(15)which is pressed into the first terminal piercing zone and the second terminal piercing zone at the rears of upper cover(8) and lower cover(9). The tusks (4) of upper cover (8) and lower cover (9) pierce into the core wires (12) of the corresponding trough (15), and connect with the conductor (14) of the corresponding core wires (12). Therefore, there is no need for the bending section at the rear end of the core wire (12) of the winding displacement rubber plug. It can make the volume of the electric connector become micro and the electric connector slimming. The piercing process can also use a related mechanic hand to clamp the upper cover (8) or the lower cover (9) and then be pressed by the related mechanic equipment for processing. It can thus make the piercing process continuous and automatic. It can further save the time and reduce the production costs.

Also, since the tusks(4) are of pyramid shape, the three tusks(4) form a V-shape or U-shape holding frame for the core wires on the vertical projecting plane. The tusks (4) have very strong structure, and the tusks (4) pierce into the core wires (12) with great force. It is not easy for tusks (4) to neither lean nor be bent or broken. The tusks (4) also have greater clamping force for the conductor (14) in the core wire (12).

What needs attention is that after the piercing process, the conductor (14) of core wires (12) is clamped by three tusks (4). The deeper the tusks (4) pierce into the core wires (12), the closer the conductor (14) of core wires (12) is to the bottom of the V-shape or U-shape holding frame for the core wires. The larger the cross section of tusks (4), the stronger the structure of tusks (4), and thus the greater the clamping force of tusks (4) to the conductor (14). Therefore, the deeper the tusks(4) pierce into core wires(12), the tighter the tusks(4) are clamping the conductor(14) of the core wires(12), which can ensure the conductor(14) not to take off and ensure the close contact between the conductor(14) and the terminals(13), thus ensuring the reliability of the electric contact.

More importantly, the internal surface of tusks (4) is the cambered surface. Therefore, when tusks (4) pierce into the core wire (12), and have contact with the conductor (14) in the core wires (12), the tusks (4) and the conductor (14) are contacted by cambered surfaces. Please see the attached drawing 24. The contact between the tusks (4) and the conductor (14) in the core wire (12) is the surface contact, and there are three contact surfaces between the tusks (4) and the conductor (14) in the core wire (12). It can significantly enhance the contact surface between the tusks (4) and the conductor (14) in the core wire (12) from two aspects. This is a tremendous advancement compared with the existing technology. Thus, this invention can greatly reduce the electric resistance between the tusks(4) and the conductor(14) in the core wire(12) and solve the problem tactfully of the high electric resistance in the electric connector of the current terminals(13) with puncture structure, improving the performance of electric connectors in all aspects, especially the data transfer, signal transfer and the high-frequency features, which allows to display the performance of the electric connector to the largest extent. Also, the deeper the tusks(4) pierce into the core wire(12), the larger the contact surface between the tusks(4) and the conductor(14) in the core wire(12), the smaller the electric resistance between the tusks(4) and the conductor(14) in the core wire(12), the better the performance of electric connectors in every aspect.

Also, what needs attention is that when tusks (4) pierce into core wires (12), the tips of tusks (4) will be deformed slightly. The proper deformation of the tusks(4) after piercing into core wires(12) is the self regulation of tusks(4), which can allow tusks(4) to regulate the contact surface between itself and the conductor(14) of the core wires(12). It can make the cambered surfaces of tusks (4) have better contact with the conductor (14) in the core wires (12), increasing the contact surface. Therefore, it can further lower electric resistance, further improving the electric performance and high-frequency features of the electric connectors.

Moreover, due to the unique combination of upper cover(8 )and terminals(13), the lower cover(9) and the terminals(13), the upper cover(8) is injected and molded in the middle and rear end of the terminals(13), and the shaft(2) of terminals(13) and the back of electric contact section(3) are imbedded in the upper cover(8).

The lower cover(9) is injected and molded in the middle and rear end of the terminals(13), and the shaft(2) of terminals(13) and the back of electric contact section(3) are imbedded in the lower cover(9). It can make the volume of the electric connector the smallest and reduce the thickness of electric connector to the smallest. It can make the thickness of the HDMI electric connector finished product far less than the thickness defined by the micro HDMI electric connector, meeting the requirements for the micro electric connector after the electric products have become micro and minimized Removal of material ribbons: remove the material ribbon (28) of terminal (13) distributed on upper cover (8) and the material ribbon (28) of terminal (13) distributed on lower cover (9). When the terminals (13) are being stamped, there is the fold where the material ribbon (28) and terminals (13) are connected. During the process of removing the material ribbons (28), one can break down the material ribbon (28) manually. One can sure sue the related tools or equipment to cut the material ribbon (28). The tools or the equipment can be the scissors or the pressing molds. Also, the removal of material ribbons (28) can be done before the piercing process or after that.

What needs attention is that the removal of material ribbon does not need to strictly follow the written sequence of this invention. It can be done before the piercing process. The work of removing the material ribbons (28) distributed on terminals (13) of upper cover and the material ribbons (28) distributed on terminals (13) of lower cover can be carried out separately or at the same time.

For assembling the front rubber core wire, see the attached drawing 18: set the front rubber core wire (10) in the front end of upper cover (8) and lower cover (9). The front rubber core wire (10), the upper cover (8), the lower cover (9) and the winding displacement rubber plug (7) assemble into a flat combination of electric connectors. Since the front rubber core wires(10) are assembled after the piercing process of terminals(13), before the assembly, it is necessary to check each terminal(13) to see whether there is the deformation, damage or breaking, ensuring the reliability of the terminals(13)'s electric connectivity.

For assembling the outer metal shell, see the attached drawing 2: the outer metal shell (11) is the stainless steel and the level and flat shell. There is the upper buckling part (22) and the lower buckling part (23) connected at the rear of the outer metal shell (11). Set the outer metal shell(11) outside of the combination of electric connectors made of the front rubber core wire(10), the upper cover(8), the lower cover(9) and the winding displacement rubber plug(7). After the outer metal shell (11) is assembled, join the upper buckling part (22) and the lower buckling part (23) at the rear of outer metal shell. The joining of the buckling part(22) and the lower buckling part(23) can fixate the core wire(12) and the wires at the tail of the winding displacement rubber plug(7) preventing the waving of the core wires(12) and the wires at the tail of winding displacement rubber plug(7), which can affect the core wires(12).

The finished products of HDMI electric connector with puncture structure The HDMI electric connector with puncture structure in this invention has a simple structure. The outer metal shell (11) is made of stainless metal and there is no need for electric plating which can pollute the environment. The main body of the electric connector is of the level and flat shape. There is not protruding or protruding section in the outer metal shell (11). The HDMI electric connector in this invention has tremendous breakthrough in being micro and slimming. The thickness of the electric connector is far less than the minimum thickness defined by the micro HDMI electric connector. With smaller thickness, the volume of the electric connector is more micro.

Also, the HDMI electric connector with puncture structure has not only avoided the disadvantages caused by welding processing, but also has tackled the unstable electric contact and high electric resistance that cannot be solved by the current HDMI electric connector with piercing structure. In the mean time, the HDMI electric connector with piercing structure has been micro and slimming.

### Embodiment 2

The processing technology of the HDMI electric connector with puncture structure: this embodiment is the continued process after each processing step in embodiment 1 has been completed. Each production step is similar to that in embodiment 1. This embodiment also includes the following steps:

Injecting of plastic shell: place the outer metal shell (11) and the electric connector combination inside the injection mould and inject a plastic shell outside the outer metal shell (11).

Since the HDMI electric connector with puncture structure in this invention has made outstanding breakthrough in being micro and slimming, the thickness of the electric connector is far less than the minimum thickness defined by the micro HDMI electric connector. Therefore, it can inject a shell outside the electric connector and the thickness of the electric connector with a shell is still very small. The thickness of the electric connector is far less than the defined size of the micro electric connectors.

What needs attention is that when the plastic shell is being injected, there can be various characters, patterns or marks on the plastic shell to make the electric connector more beautiful. Additionally, there can also be various skid-proof structure on the plastic shell, such as the raised grain, heaves or concave anti-slip block, which can allow the skid-proof function for the electric connector and enhance the hand feel of the electric connector.

### Embodiment 3

For the terminals with puncture structure, see the attached drawings 19 to 26. The front end of terminal (13) is the electric contact section (1), the middle of terminal (13) is the shaft (2), and the rear of terminal (13) is the electric contact section (3). There are at least two tusks (4) with intertwining tips formed in electric contact section (3). The tusk (4) is of pyramid shape. The internal side of tusk (4) forms a cambered surface.

There are three tusks (4) arrayed in electric contact section of terminal (13). The internal sides (5) of the tusks (4) located at the front end and the rear end is of the same direction, while they are of the opposite direction from the internal sides (4) located in the middle. The cambered surface is formed in the upper end of the internal side (5) of the tusk (4).

The said three tusks (4) form a V-shape or U-shape holding frame for the core wires on the vertical projecting plane. The front of terminal (13) turns 90 degrees around the rear of terminal (13). See attached drawing 23. The front end of the terminals (13) turns 90 degrees around the rear end of terminals (13). The shaft (2) forms a torsion section (6).

For the electric connectors using the terminals (12) in this invention, during the assembly, the tusks (4) pierce into the core wires (12) vertically. Thus, there is no need for the bending section at the end core wires (12) which are either fixated in the winding displacement rubber plug (7) or related components. Reducing the space used for arraying core wires (12) significantly can allow the volume of electric connectors to be micro and the electric connector to be more slimming.

Additionally, the tusks(4) are of pyramid shape and the three tusks(4) form a V-shape or U-shape holding frame for the core wires on the vertical projecting plane. The tusks (4) have very strong structure, and the tusks (4) pierce into the core wires (12) with great force. It is not easy for tusks (4) to lean nor be bent or broken. The tusks (4) also have greater clamping force for the conductor (14) in the core wire (12).

What needs the attention is that: after the piercing process, the conductor (14) of core wires (12) is pressed by three tusks (4). The deeper the tusks(4) pierce into core wires(12), the closer the conductor(14) of core wires(12) are getting to the bottom of the V-shape or U-shape holding frame for core wires, the larger the cross section of tusks(4), the stronger the structure of the tusks(4) the tighter the tusks(4) are clamping the conductor(14) of the core wires(12),. Thus, The deeper the tusks(4) pierce into core wires(12), the tighter the tusks(4) of core wires(12) clamp the conductor(14), which can ensure the conductor(14) not to take off and ensure the close contact between the conductor(14) and the terminals(13), thus ensuring the reliability of the electric connectivity.

More importantly, the internal surface of tusks (4) is the cambered surface. Therefore, when tusks (4) pierce into the core wire (12), and have contact with the conductor (14) in the core wires (12), the tusks (4) and the conductor (14) are contacted by cambered surfaces. Please see the attached drawing 24. The contact between the tusks (4) and the conductor (14) in the core wire (12) is the surface contact, and there are three contact surfaces between the tusks (4) and the conductor (14) in the core wire (12). It can significantly enhance the contact surface between the tusks (4) and the conductor (14) in the core wire (12) from two aspects. This is a tremendous advancement compared with the existing technology. Thus, this invention can greatly reduce the electric resistance between the tusks(4) and the conductor(14) in the core wire(12) and solve the problem tactfully of the high electric resistance in the electric connector of the current terminals(13) with puncture structure, improving the performance of electric connectors in all aspects, especially the data transfer, signal transfer and the high-frequency features, which allows to display the performance of the electric connector to the largest extent. Also, the deeper the tusks(4) pierce into the core wire(12), the larger the contact surface between the tusks(4) and the conductor(14) in the core wire(12), the smaller the electric resistance between the tusks(4) and the conductor(14) in the core wire(12), the better the performance of electric connectors in every aspect.

What needs attention is that The deeper the tusks (4) pierce into the core wires (12), the larger the contact surface between the tusks (4) and the conductor (14) of the core wires (12), and the smaller the electric resistance between the tusks and the conductor (14) of the core wires (12), the better the performance of the electric connector in every aspect.

Also, when tusks (4) pierce into core wires (12), the tips of tusks (4) will be deformed slightly. The proper deformation of the tusks(4) after piercing into core wires(12) is the self regulation of tusks(4), which can allow tusks(4) to regulate the contact surface between itself and the conductor(14) of the core wires(12). It can make the cambered surfaces of tusks (4) have better contact with the conductor (14) in the core wires (12), increasing the contact surface. Therefore, it can further lower electric resistance, further improving the electric performance and high-frequency features of the electric connectors.

Also, terminals (13) with puncture structure in this invention also has tackled the unstable, poor electric contact and high electric resistance that cannot be solved by the current terminals (13) with piercing structure. It has simple structure and small size, easy for production and low in production costs.

### Embodiment 4

The components of terminals with puncture structure belonging to an HDMI electric structure with puncture structure, see the attached drawings 7 to 17. It includes the upper cover (8) and the lower cover (9) whose top and bottom are joined. The upper cover (8) is injected in the middle and rear section of the arrayed terminals (13). The shaft (2) and the rear of terminal (13) are imbedded inside the upper cover (8). There is the trough (26) in the rear of upper cover (8). The tusk (4) of electric contact section (3) located in the rear of terminal (13) are located in the upper cover trough (26), and the tusk (4) extends to the inner surface of the upper cover trough (26).

The lower cover (9) is injected in the middle the middle and rear section of the arrayed terminals (13).

The shaft (2) and the rear of terminal (13) are imbedded inside the lower cover (8). There is the trough (26) in the rear of lower cover (8). The tusk (4) of electric contact section (3) located in the rear of terminal (13) are located in the lower cover trough (26), and the tusk (4) extends to the inner surface of the lower cover trough (26).

In the components of terminals with puncture structure in this convention, the unique combination of upper cover (8) and the terminals (13) make the structure simpler, allowing the volume of the electric connector to be more micro and slimming.

Additionally, as the upper cover (8) is injected at the middle and rear sections of the arrayed terminals (13), the injection is of the one-piece type. The shaft (2) of terminals (13) distributed on the upper cover (8) and the rear back of the terminal (13) is imbedded in the upper cover (8). The terminals (13) and the upper cover (8) are firmly connected. The injection process for the upper cover (8) has been mechanized and automatized, and there is no need to fill terminals (13) one by one, which can reduce the number of operators, save the time and lower production costs.

In a similar way, the unique combination of lower cover (9) and the terminals (130 make the structure more simple, allowing the volume of the electric connector to be more micro and slimming. As the lower cover is injected at the middle and rear sections of the arrayed terminals, the injection is of the one-piece type. The shaft (2) of terminals (13) distributed on the lower cover (9) and the rear back of the terminal (13) are imbedded in the lower cover (9). The terminals (13) and the lower cover (9) are firmly connected. The injection process for the lower cover (9) has been mechanized and automatized, which can reduce the work time and production costs.

### Embodiment 5

For the HDMI electric connector with puncture structure, see attached drawings 2 to 26. It includes the winding displacement rubber plug (7), the upper cover (8), the lower cover (9), the terminals (13), the front rubber core wires (10) and the outer metal shell (11). There are wire chases (15) in the upper surface and lower surface of the said winding displacement rubber plug (7). The core wires (12) are pressed into the corresponding wire chase (15) in the winding displacement rubber plug (7), thus making the core wires (12) arrayed and fixated on winding displacement rubber plug (7).

There is the internal mold's filling chamber (17) at the rear end of the said winding displacement rubber plug. There is one internal mold(16) injected in the internal mold's filling chamber(17) at the rear end of the winding displacement rubber plug after the core wires(12) have been arrayed. The internal chamber (16) covers and fixates each core wire (12). Meanwhile, internal mold(16) is fixated at the rear end of the winding displacement rubber plug(7), thus completely fixating each core wire(12), and ensuring the core wire(12) not to take off from the wire chase(15)

The mentioned upper cover (8) is injected on the arrayed terminals (13). The terminals (13) stamped in advance are still connected by the material ribbon (28) and the terminals (13) have been arrayed. The material ribbon (28) can array and fixate each terminal (13). Therefore, it is very convenient to inject the upper cover (8) on the terminal (13). There is no need of special tools or hold-down clamp to fixate the terminals (13).

The upper cover (8) is injected and molded. The shaft (2) and the rear back of the terminals (13) are imbedded in the upper cover (8). There is the tusk (4) in the rear end of the terminal (13). The tusk (4) can be standing upright on the internal surface of upper cover (8); the tusks (4) can also form a certain leaning angle with the internal surface of the upper cover (8). Each tusk (4) is located in the upper cover trough (26) at the rear location of the internal surface of the upper cover (8).

The unique combination of lower cover (9) and the terminals (130 make the structure simpler, allowing the volume of the electric connector to be more micro and slimming. And the terminals(13) are firmly connected with the upper cover(8) The injection process for the lower cover(9) has been mechanized and automatized, which can reduce number of operators, the work time and lower production costs. There are two positioning pillars (24) on the internal surface of the upper cover (8).

The said lower cover (9) is injected in the arrayed terminals (13). Terminals (13) stamped in advance are still connected by the material ribbon (28). The material ribbon (28) can array and fixate each terminal (13). Therefore, it is very convenient to inject the upper cover (8) on the terminal (13). There is no need of special tools or hold-down clamp to fixate the terminals (13).

The lower cover (9) is injected and molded. The shaft (2) and the rear back of the terminals (13) are imbedded in the lower cover (9). There is the tusk (4) in the rear end of the terminal (13). The tusk (4) can be standing upright on the internal surface of lower cover (9); the tusks (4) can also form a certain leaning angle with the internal surface of the lower cover (9). Each tusk (4) is located in the lower cover trough (27) at the rear location of the internal surface of the lower cover (9).

The unique combination of lower cover (9) and the terminals (130 make the structure simpler, allowing the volume of the electric connector to be more micro and slimming. And the terminals(13) are firmly connected with the upper cover(8) The injection process for the lower cover(9) has been mechanized and automatized, which can reduce number of operators, the work time and lower production costs. There are two positioning pillars (24) on the internal surface of the upper cover (8).

There is the position pillar (24) and the position hole (25) on the internal surface. Of said lower cover (9). When the upper cover(8) and the lower cover(9) are joined, the position pillar(24) is insert into the position hole(25) and the position pillar(24) and the positioning hole(25) play the role of steering and positioning to prevent the misallocation when the upper cover(8) and the lower cover(9) are joined.

The both sides of the said upper cover (8) extend to the joint feet (18). There is the button placement (19) on both sides of the lower cover (9). When the upper cover (8) and the lower cover (9) are joined, the joint feet (18) on the upper cover are locked into the button placement (19) of the lower cover (19).

When the upper cover (8) and the lower cover (9) are joined, the winding displacement rubber plug (7) is pressed at the rears of the upper cover (8) and the lower cover (9). The sections where there are the wire chases (15) in the winding displacement rubber plug (7) are located within the upper cover trough (26) and the lower cover trough (270 of upper cover (8) and the lower cover (9). The tusks(4) of the terminals(13) located within the upper cover trough(26) and the lower cover trough(27) are aligned with the upper surface and lower surface wire chases(15) of the winding displacement rubber plug. When the upper cover(8) and the lower cover(9) are connected, the tusks(4) of terminals(13) on the upper cover(8) and the lower cover(9) will pierce into the corresponding core wires(12) fixated in the winding displacement rubber plug(7). The terminals (13) of upper cover (8) and the lower cover (9) have electric connectivity with the conductor (14) of the core wires (12) through their tusks (4). When assembling the upper cover(8) and the lower cover(9) and the winding displacement rubber plug together, one only needs to position the winding displacement rubber plug(7) on the related location of the upper cover(8), and then put the upper cover(8) atop the lower cover(9). Then the assembly of he upper cover (8) and the lower cover (9) and the winding displacement rubber plug has been completed. You can use your hands to press the upper cover (8), or use mechanical hold-down clamps or tools.

When the pressing is completed, the tusks(4) of terminals(13) of the upper cover(8) and the lower cover(9) pierce into the corresponding core wires(12) on the winding displacement rubber plug(7). It forms the electric connectivity between the terminals (13) and the conductor (14) of the core wires (12). The assembly is simple and convenient, with no need of welding, getting rid of the various problems brought forth by the welding process. Additionally, since the terminals (13) are imbedded and fixated in the upper cover (8) or the lower cover (9), it makes the structure of electric connector more compacted and allows it to become more micro and slimming. The thickness of electric connector is smaller and it can meet the need for micro and slimming electric connectors used in the various electronic products nowadays.

The front end of the said terminal (13) is the electric contact section (1), the middle is the shaft (2) and the rear of the terminal (13) is the electric connection section (3). There are three tusks (4) in the electric connection section (3) of the terminals (13) whose tips are intertwining. The three tusks (4) are vertical to the shaft (2) of terminals (13). The tips of the three tusks (4) respectively extend to the outside. The internal sides (5) of the tusks (4) located at the front end and the rear end are of the same direction, while they are of the opposite direction from the internal sides (4) located in the middle. The cambered surface is formed in the upper end of the internal side (5) of the tusk (4).

Therefore, there is no need for the bending section at the rear end of the core wire (12) of the winding displacement rubber plug (7). It can make the volume of the electric connector become micro and the electric connector slimming.

The three mentioned tusks (4) form a V-shape or U-shape holding frame for the core wires on the vertical projecting plane. The tusks (4) are of pyramid shape, and the internal sides of the tusks (4) are the cambered surface. The cambered surface is formed in the upper end of the tusks (4)′ internal sides. Since the tusks (4) are of pyramid shape, the tusks (4) have very strong structure, and the tusks (4) pierce into the core wires (12) with great force. It is not easy for tusks (4) to lean nor be bent or broken. The tusks (4) also have greater clamping force for the conductor (14) in the core wire (12).

The holding frame for the core wires formed by three tusks (4) is of V shape or U shape, and the internal side of tusks (4) is the cambered surface. When tusks (4) pierce into the core wires (12), the conductor (14) of core wires (12) is pressed in the V-shape or U-shape holding frame. The conductor (14) of core wires (12) is clamped by three tusks (4). The deeper the tusks (4) pierce into the core wires (12), the closer the conductor (14) of core wires (12) is to the bottom of the V-shape or U-shape holding frame for the core wires. The larger the cross section of tusks (4), the stronger the structure of tusks (4), and thus the greater the clamping force of tusks (4) to the conductor (14). Therefore, the deeper the tusks(4) pierce into core wires(12), the tighter the tusks(4) are clamping the conductor(14) of the core wires(12), which can ensure the conductor(14) not to take off and ensure the close contact between the conductor(14) and the terminals(13), thus ensuring the reliability of the electric contact.

What needs attention is that: the tusks (4) are of the pyramid shape, and the internal surface of tusks (4) is the cambered surface, while the conductor (14) of the core wires (12) is the cylinder shape.

Therefore, when tusks (4) pierce into the core wire (12), and have contact with the conductor (14) in the core wires (12), the tusks (4) and the conductor (14) are contacted by cambered surfaces. The contact between the tusks (4) and the conductor (14) in the core wire (12) is the surface contact, and there are three contact surfaces between the tusks (4) and the conductor (14) in the core wire (12). It can significantly enhance the contact surface between the tusks (4) and the conductor (14) in the core wire (12) from two aspects. This is a tremendous advancement compared with the existing technology. Thus, this invention can greatly reduce the electric resistance between the tusks(4) and the conductor(14) in the core wire(12) and solve the problem tactfully of the high electric resistance in the electric connector of the current terminals(13) with puncture structure, improving the performance of electric connectors in all aspects, especially the data transfer, signal transfer and the high-frequency features, which allows to display the performance of the electric connector to the largest extent. Also, the deeper the tusks(4) pierce into the core wire(12), the larger the contact surface between the tusks(4) and the conductor(14) in the core wire(12), the smaller the electric resistance between the tusks(4) and the conductor(14) in the core wire(12), the better the performance of electric connectors in every aspect.

Also, what needs attention is that when tusks (4) pierce into core wires (12), the tips of tusks (4) will be deformed slightly. The proper deformation of the tusks(4) after piercing into core wires(12) is the self regulation of tusks(4), which can allow tusks(4) to regulate the contact surface between itself and the conductor(14) of the core wires(12). It can make the cambered surfaces of tusks (4) have better contact with the conductor (14) in the core wires (12), increasing the contact surface. Therefore, it can further lower electric resistance, further improving the electric performance and high-frequency features of the electric connectors.

The front end of the said terminal (13) turns 90 degrees around the rear end of terminal (13). The shaft (2) forms a torsion section (6). The torsion section (6) makes the terminal (13) join better with the upper cover 8 or lower cover 9. When the upper cover 8 or lower cover 9 is injected and molded, the shaft(2) can be more firmly imbedded within upper cover (8) or lower cover(9), thanks to the existence of torsion section(6). The terminals (13) will not become loose off or take off.

In addition, it is hard or impossible to stamp the tusk(4) which is vertical to the shaft(2) of terminal(13) on the terminals(13), therefore, the design of torsion section 6 in shaft(2) can not only make tusks(4) vertical to the shaft(2) of terminals(13), but also simplify the structure of terminals(13), making it easier for production. It can also make it possible to mechanize, automatize and industrialize the production of terminals (13), especially the tusks (4) of terminals (13). The terminals(13) can stamp the electric contact section(1), shaft(2) and the tusks(4) placed horizontally, and then make the shaft(2) turn by 90 degrees, thus allowing the tusk(4) to be vertical to the shaft(2) of the terminals(13). It can simplify the production of terminals (13). Also, it makes it possible to make micro and slimming electric connector. The electric connectors using this kind of terminals (13) are thinner.

Additionally, the terminals (13) have very strong structure, and the cambered surface of tusks (4) is contacted with the conductor (14) of the core wires (12). Therefore, the terminals (13) in this invention can not only pierce into the single-wire core wires (12), see the attached drawing 24; it can also pierce into multicore core wires (12), refer to the attached drawings 25 and 26. The purpose for electric connection is realized by replacing the welding process by the puncture structure. The terminals (13) in this invention not only have the advantages of terminals (13) with puncture structure, but also have close contact with the conductor (14) of core wires (12). The contact area is large and the electric resistance is small, which can fully display the function of electric connectors in every aspect.

When the upper cover (8) and the lower cover (9) are joined, the front rubber core wires (10) are set on the front end of the upper cover (8) and the lower cover (9). The electric contact section (1) of terminals (13) is inserted in the internal chamber of the front rubber core wires (10). there is the hook(8a) on the outer surface of upper cover(8), and there is the hook(9a) on the outer surface of lower cover(9), there are the windows(21) going through the front rubber core wires(10) on the upper surface and lower surface of the front rubber core wires(10). So, when the front rubber core wires(10) are assembled in the front end of the upper cover(8) and the lower cover(9), the hook(8a) of the upper cover(8) and the hook(9a) of the lower cover(9) hook up with the windows(21) on the upper surface and lower surface of the front rubber core wire(10), thus setting the front rubber core wires(10) on the front end of the upper cover(8) and the lower cover(9). Since the front rubber core wires (10) is assembled after the piercing process is completed, before assembling the front rubber core wires (10), make sure to check each terminal (13) and confirm whether they are deformed and terminals (13) have been damaged or broken, ensuring that terminals (13) can be used and guaranteeing the reliability of the electric connectivity of terminals (13).

Therefore, the deeper the tusks(4) pierce into core wires(12), the tighter the tusks(4) are clamping the conductor(14) of the core wires(12), which can ensure the conductor(14) not to take off and ensure the close contact between the conductor(14) and the terminals(13), thus ensuring the reliability of the electric contact.

The front rubber core wires (10), the upper cover (8), the lower cover (9) and the winding displacement rubber plug (7) are assembled and form a flat combination. The overall volume is smaller and it is thinner.

The outer metal shell covers the outside of the front core wire (10), the upper cover (8), and the lower cover (9) from the front to the back. The said outer metal shell (11) is a one-piece type. The rear of the outer metal shell (11) is the upper buckling part (22) and the lower buckling part (23). The upper buckling part (22) and the lower buckling part (23) are connected after the outer metal shell (11) has been assembled. The front end of the outer metal shell (11) is the level and flat shell.

The compacted structure of the front rubber core wire (10), the upper cover (8), the lower cover (9) and the winding displacement rubber plug (7), which make the whole combination of electric connectors more micro and slimming. Therefore, after the assembly, the combination of electric connectors is of flat shape. Thus, the front ends of the front rubber core wire(10), the upper cover(8), the lower cover(9) and the winding displacement rubber plug(7) can be level and flat. There is no heave or protruding part on the outer surface of the outer metal shell (11), which allows the electric connector to achieve further micro and slimming effects. So, there is sufficient space on the surface of outer metal shell (11) for injecting the plastic shell. The electric connector with injected plastic shell remains micro and slimming.

The injected plastic shell makes the electric connector look more beautiful while maintaining its micro and slimming features. If there are the skid-proof designs on the plastic shells, it can lend the skid-proof function to the electric connectors.

The above are only the better embodiments of this invention. So any changes or modifications according to the mentioned structure, characteristics and principles stated in the patent application for this invention shall be included in the scope of this patent application for this invention.

What is claimed is:

1. A processing technique of a piercing HDMI electric connector comprising the following steps:
stamping terminal processing, terminal (13) from stamping molding, the front of terminal (13) is the electric contact section (1). the middle of terminal (13) is the shaft (2); the rear of terminal (13) is electric contact section (3) with molded tusk (4) on it;
winding displacement processing arranges and fixates the core wire (12) on the upper surface and the wire chase (15) on the lower surface of winding displacement rubber plug;
injecting upper cover: place a group of terminals distributed on the upper cover (8) in the injection mold. do injection molding on the middle and rear sections of this group of arrayed terminals (13) and the mold goes out from upper cover (8). the middle and rear sections of terminal (13) are hidden in upper cover (8). the tusk (4) of electric connector (3) stands on the inner surface of upper cover (8). the rear end of upper cover (8) forms the first piercing zone for the terminals;
injecting lower cover: place an array of terminals (13) distributed on the lower cover(9) in the injection mold; mold the middle and rear section of this array of distributed terminals into the shape and go out of lower cover (9). the middle and rear section of terminals (13) are imbedded in the lower cover (9). the tusk (4) of electric contact section (3) stands on the inner surface of lower cover (9). the rear of lower cover (9) forms a second terminal piercing zone;
piercing processing: assemble upper cover (8), lower cover (9) and the winding displacement rubber plug (7) fixated with core wires (12), join the top and bottom of the upper cove (8) and the lower cover (9). there is the trough section with a trough (15) which is pressed into the first terminal piercing zone and the second terminal piercing zone at the rears of upper cover (8) and lower cover (9). the tusks (4) of upper cover (8) and lower cover (9) pierce into the core wires (12) of the corresponding trough (15), and connect with the conductor (14) of the corresponding core wires (12);
removing the material ribbons: remove the material (28) of terminal (13) distributed on upper cover (8) and the material (28) of terminal (13) distributed on lower cover (9). assemble the front rubber core wire: set the front rubber core wire (10) in the front end of upper cover (8) and lower cover (9). the front rubber core wire (10), the upper cover (8), the lower cover (9) and the winding displacement rubber plug (7) assemble into a flat combination of electric connectors;
assemble the outer metal shell: set the outer metal shell( 1) outside of the combination of electric connectors made of the front rubber core wire(10), the upper cover(8), the lower cover(9) and the winding displacement rubber plug(7);
the finished product of hdmi electric connector with puncture structure.

2. The processing technique of a piercing HDMI electric connector of claim 1, wherein the said processing technology of hdmi electric connector with puncture structure is featured in that the mentioned stamping terminal processing has the following steps:
stamp the terminals distributed on the upper cover, at least stamp an array of terminals (13) distributed on the upper cover (8). the terminals (13) from stamping have been arrayed and connected by material ribbons (28);
stamp the terminals distributed on the upper cover, at least stamp an array of terminals (13) distributed on the upper cover (9). the terminals (13) from stamping have been arrayed and connected by material ribbons (28);
a material ribbon (28) at least connects one array of terminals (13) distributed on upper cover (8) and/or terminals (13) distributed on the lower cover (9);
the tusks (4) from stamping on terminals (13) are arrayed in the electric contact section (3) of terminals (13). the tusk (4) is of pyramid shape. the inner side (5) of the tusk (4) forms a cambered surface. the tusk (4) forms a v-shape or u-shape holding frame for the core wire on the vertical projecting plane. the front end of terminals (13) turns 90 degrees around the rear end of terminal (13).

3. The processing technique of a piercing HDMI electric connector of claim 2, wherein the said processing technology of HDMI electric connector with puncture structure is featured in that the mentioned injection process of upper cover is replaced by the process of upper cover assembled terminal, or mentioned injection process of lower cover is replaced by the process of lower cover assembled terminal; the processing of upper cover assembled terminals is: inject the upper cover (8), assemble an array of terminals(13) distributed on the corresponding upper cover(8) above upper cover(8), and the rear end of upper cover(8) forms the first terminal piercing zone;
the processing of lower cover assembled terminals is: inject the lower cover (9), assemble an array of terminals(13) distributed on the corresponding lower cover(9) above lower cover(9), and the rear end of lower cover(9) forms the first terminal piercing zone.

4. The processing technique of a piercing HDMI electric connector of claims 1, wherein the said processing technology of HDMI electric connector with puncture structure is featured in that one step to inject the inner mold is added before the piecing process; place the winding displacement rubber plug (7) inside the injection mold; inject the inner mold (16) at the rear of winding displacement rubber plug (7); the inner mold (16) is fixated at the rear of winding displacement rubber plug (7). meanwhile, the inner mold (16) covers and completely fixates all core wires (12).

5. The processing technique of a piercing HDMI electric connector of claim 4, wherein the said processing technology of HDMI electric connector with puncture structure is featured in that in the step of assembling the front rubber core wires, the hook(8a) of upper cover(8) and the hook(9a) of the lower cover(9) are respectively snapped into the lock joint(19) of the upper surface and the lower surface of the front rubber core wire(10), thus fixating the front rubber core wire(10) in the front end of upper cover(8) and lower cover(9); during the piercing process, the top and bottom of upper cover(8) and lower cover(9) are joined and pressed by the tools and the hold-down clamp, or by manual pressing. the upper cover (8) and lower cover (9) are positioned and steered by their position pillar (24) and the position hole (25) on the internal surface; the upper cover (8) and the lower cover (9) are joined by the lock feet (18) and button displacement (19) on their both sides.
in the step of assembling the outer metal shell, the said outer metal shell (11) is the flat and level shell, the rear of outer metal shell (11) is connected with the upper buckling part (22) and the lower buckling part (23).

6. The processing technique of a piercing HDMI electric connector of claim 5, wherein the said processing technology of HDMI electric connector with puncture structure is featured in that a step to add an outer metal shell after assembling the outer metal shell. Place the outer metal shell (11) and the electric connector combination inside the injection mold. Inject a plastic outer shell outside the outer metal shell (11).

7. A terminal with puncture structure comprising the front end of terminal (13) is the electric contact section (1), the middle of terminal (13) is the shaft (2), and the rear of terminal (13) is the electric contact section (3), there are at least two tusks (4) with intertwining tips formed in electric contact section (3), the tusk (4) is of pyramid shape, the internal side of tusk (4) forms a cambered surface.

8. The terminal with puncture structure of claim 7, wherein the said terminal with puncture structure is featured in that there are three tusks (4) arrayed in electric contact section of terminal (13), the internal sides (5) of the tusks (4) located at the front end and the rear end are of the same direction, while they are of the opposite direction from the internal sides (4) located in the middle, the cambered surface is formed in the upper end of the internal side (5) of the tusk (4).

9. The terminal with puncture structure of claims 7, wherein the said terminal with puncture structure is featured in that the said tusks (4) form a V-shape or U-shape holding frame for the core wires on the vertical projecting plane.

10. The terminal with puncture structure of claim 9, wherein the said terminal with puncture structure is featured in that the front of terminal (13) turns 90 degrees around the rear of terminal (13), the shaft (2) forms a torsion section (6).

11. A component of the HDMI electric connector with puncture structure comprising the upper cover (8) and the lower cover (9) whose top and bottom are joined; the upper cover (8) is injected in the middle and rear section of the arrayed terminals (13), the shaft (2) and the rear of terminal (13) are imbedded inside the upper cover (8); there is the trough (26) in the rear of upper cover (8); the tusk (4) of electric contact section (3) located in the rear of terminal (13) are located in the upper cover trough (26), and the tusk (4) extends to the inner surface of the upper cover trough (26);
the lower cover (9) is injected in the middle the middle and rear section of the arrayed terminals (13);
the shaft (2) and the rear of terminal (13) are imbedded inside the lower cover (8). there is the trough (26) in the rear of lower cover (8); the tusk (4) of electric contact section (3) located in the rear of terminal (13) are located in the lower cover trough (27), and the tusk (4) extends to the inner surface of the lower cover trough (27).

12. An HDMI electric connector with puncture structure comprising the winding displacement rubber plug (7), the upper cover (8), the lower comprising cover (9), the terminal (13), the front rubber core wire (10) and the outer metal shell (11), the core wires (12) are arrayed and fixated in the winding displacement rubber plug (7), the upper cover (8) is injected and molded in the arrayed terminal (13), there is the tusk (4) in the rear end of the terminal (13), the tusk (4) stands upright on the internal surface of upper cover (8);
the lower cover (8) is injected and molded in the arrayed terminal (13). there is the tusk (4) in the rear end of the terminal (13), the tusk (4) stands upright on the internal surface of the lower cover (8), the winding displacement rubber plug (7) is pressed in the rear end of the upper cover (8) and the lower cover (9), the tusks (4);
the upper cover (8) and the lower cover (9) are joined and connected at the top and the bottom, the tusks(4) of the upper cover(8) and the lower cover(9) pierce respectively the corresponding core wires(12) fixated in the winding displacement rubber plug(7), and the tusks (4) are connected with conductor (14) in the corresponding core wires (12), the front rubber core wire (10) is set the joined fronts of the upper cover and the lower cover. the electric contact section (1) of terminal (13) is inserting in the inner chamber of the front rubber core wire (10), the outer metal shell (11) covers the outside of the front rubber core wire (10), the upper cover (8) and the lower cover (9).

13. The HDMI electric connector with puncture structure of claim 12, wherein the said HDMI electric connector with puncture structure is featured in that the front of terminal (13) is the electric contact section (1), the middle of the terminal (13) is the electric contact section (3), and the shaft (2) of terminal (13) and rear back of the terminal are imbedded in the upper cover (8) or the lower cover (9); there are at least two tusks (4) with intertwining tips on the electric connector (3). The tips of tusks (4) lean to the outside respectively; the tusk (4) is of pyramid shape. The internal sides (5) of the tusk (4) form the cambered surface.

14. The HDMI electric connector with puncture structure of claim 13, wherein the said HDMI electric connector with puncture structure is featured in that there are three tusks(4) arrayed in the electric contact section(3) of the terminal(13). the internal sides(5) of the tusks(4) located in the front end and the rear end are of the same direction, and are of the opposite direction from internal sides(5) of the tusk(4) located in the middle; the cambered surface is formed in the upper end of the internal side (5) of the tusk (4). the three tusks (4) make a v-shape or u-shape holding frame for the core wires in the vertical projecting surface; the front end of terminal (13) turns 90 degrees around the rear end of terminal (13), the shaft (2) forms a torsion section (6).

15. The HDMI electric connector with puncture structure of claims 12, wherein the said HDMI electric connector with puncture structure is featured in that the two sides of upper cover(8) respectively extends to the joint feet(18). there is the button placement (19) on the two sides of the lower cover (9); when the upper cover (8) and the lower cover (9) are joined and connected, the joint feet (18) of upper cover (8) is snapped in the button placement (19) of the lower cover; there is the hook (8a) on the outer surface of the said upper cover (8), and there is the hook (9a) on the outer surface of the lower cover (9); there are the windows (21) that go through the front rubber core wire (10) on the upper surface and lower surface of the front rubber core wire. when the front rubber core wire(10) is assembled on the front end of the upper cover(8) and the lower cover(9), the hook(8a) of the upper cover(8) and the hook of the lower cover(9) are respectively hooked in the windows(21) on the upper surface and lower surface of the front rubber core wire(10); the upper surface and lower surface of the said winding displacement rubber plug are forming the wire chase (15) respectively; there is the internal mold's filling chamber (17) at the rear end of the winding displacement rubber plug; there is one internal mold (16) injected in the internal mold's filling chamber (17) at the rear end of the winding displacement rubber plug; the internal chamber (16) covers and fixates each core wire (12).

16. The HDMI electric connector with puncture structure of claim 15, wherein the said HDMI electric connector with puncture structure is featured in that the outer metal shell (11) is the metal shell. the outer metal shell (11) is the level and flat shell; the rear of the outer metal shell (11) is connected with the upper buckling part (22) and the lower buckling part (23); after the outer metal shell (11) is assembled, the upper buckling part (22) and the lower buckling part (23) are joined and connected; there is the plastic shell injected and molded on the outer surface of the outer metal shell (11).
